(19) United States
(12) Patent Application Publication
(10) Pub. No.: US 2014/0242720 A1
(43) Pub. Date: Aug. 28, 2014

(54) KIT FOR IMMUNO-CHROMATOGRAPHY, REAGENT FOR IMMUNO-CHROMATOGRAPHY, AND METHOD OF DETECTING USING THEM

(71) Applicant: FURUKAWA ELECTRIC CO., LTD., Tokyo (JP)

(72) Inventors: Masataka NISHIDA, Tokyo (JP); Hideki AIZAWA, Tokyo (JP)

(73) Assignee: FURUKAWA ELECTRIC CO., LTD., Tokyo (JP)

(21) Appl. No.: 13/778,609

(22) Filed: Feb. 27, 2013

(51) Int. Cl. G01N 21/64

(52) U.S. Cl. CPC G01N 21/6486
USPC 436/501

(57) ABSTRACT

A kit for immunochromatography, having: a planar test strip having a test area and a reference area, the test area having a test purpose capturing substance, the reference area having a reference purpose capturing substance; fluorescent particulates provided with a binding property to a target substance, the target substance provided with a binding property to the test purpose capturing substance; and light absorbing particulates provided with a binding property to the reference purpose capturing substance.

### TECHNICAL FIELD

The present invention relates to a kit for immunochromatography, reagent for immunochromatography, and method of detecting using them.

### BACKGROUND ART

As a method of detecting a trace amount substance contained in a living body, e.g., an antibody, there is a medical test based on lateral flow type immunochromatography. According to the test, an analyte substance contained in an analyte liquid is captured by labeling particles, and then the particles are transported along a porous support based on capillary phenomenon. Then, it is brought into contact with a capturing substance which is immobilized, for example, in line shape in a porous support. As a result, the analyte substance is concentrated and a line immobilized with capturing substance exhibits color. Based on the color exhibition, it can be determined as to the presence or the absence of the analyte substance. Regarding such an immunochromatography, three features can be pointed as follows:
(1) Prompt test can be made, as the time is short to reach the identification.
(2) Simple operation, as the test can be made only by applying an analyte.
(3) Easy determination, as no special detection device is required.

By taking advantage of those characteristic aspects, immunochromatography is used for a pregnancy test reagent or for an influenza test reagent, and also utilized as a new method of POCT (Point Of Care Testing). Further, for example, in a field of food testing, it receives more attention and is popularized as a reagent for detecting a food allergen.

The above term “POCT” means a test for diagnosing a patient at possibly nearest place. Conventionally, a collected analyte like blood, urine, and tissues of lesion is sent to a central test lab of a hospital or a professional test center to obtain the data, and thus it takes a time to have a confirmed diagnosis. However, according to POCT, a fast yet accurate treatment can be made, based on the test information which is supplied in short time. From such point of view, it enables an urgent test or a test during operation at hospital, and it is highly needed at actual medical site, in particular.

In view of the requirements described above, the applicant studied for developing a reagent for application to a membrane, and as a result, developed a technique of using fluorescent silica particulates (see, Patent Document 1, etc.). As a result, compared to conventional technologies in which a biological substance, cells from a living body, or colloidal gold particle is used, measurement and detection can be attained at low cost with significantly high stability. In addition, as a need like improving detection sensitivity and quantification can be met more appropriately, it makes a great contribution to broadening the application area of immunochromatography.

The applicant also suggested a conjugate pad in which fluorescent silica particulates and light absorbing silica particulates are used in combination (see, Patent Document 2). Consequently, it was made possible that detection can be made even in a state of not having fluorescence irradiation, and if necessary, by performing fluorescence detection, improvement of detection accuracy and quantitative measurement can be carried out simultaneously.

### CITATION LIST

### Patent Document

{Patent Document 1} WO2008/018566 pamphlet
{Patent Document 2} JP-A-2010-014631

### DISCLOSURE OF INVENTION

The present invention relates to a kit for immunochromatography, having:

a planar test strip having a test area and a reference area, the test area having a test purpose capturing substance, the reference area having a reference purpose capturing substance;

fluorescent particulates provided with a binding property to a target substance, the target substance provided with a binding property to the test purpose capturing substance; and

light absorbing particulates provided with a binding property to the reference purpose capturing substance.

Other and further features and advantages of the invention will appear more fully from the following description, appropriately referring to the accompanying drawings.

### BRIEF DESCRIPTION OF DRAWINGS

FIG. 1 is an exploded perspective view schematically illustrating the test stick as a preferred embodiment of the invention.

FIG. 2 is a view schematically illustrating the immobilized state of labeling particles in a test area and also in a reference area as a preferred embodiment of the invention.

### BEST MODE FOR CARRYING OUT THE INVENTION

Further, inventors of the present invention continuously studied immunochromatography using the fluorescent particulates (hereinafter, it may be also referred to as fluorescent immunochromatographic test). As a result, the inventors found that, as more particulates are adsorbed on a control line than a test line, the former tends to have higher emission light intensity than the latter. In such a situation, in case that highly sensitive determination is carried out as to a positive or negative response, due to light emission of the control line in high emission light intensity, the visibility of the test line is impaired with weaker emission light intensity.

Thus, the present invention and embodiments contemplates the provision of a specific inventive means as to the fluorescent immunochromatographic test. In particular, the present invention and embodiments contemplates the provision of a kit for immunochromatography, which enables suppression or prevention of decrease in visibility of test line fluorescence caused by fluorescent light emission of control line, a method of detecting by using it, and a reagent to be used therefor.

According to the present invention and the embodiments, the following means are provided.

{1} A kit for immunochromatography, having:

a planar test strip having a test area and a reference area, the test area having a test purpose capturing substance, the reference area having a reference purpose capturing substance;

fluorescent particulates provided with a binding property to a target substance, the target substance provided with a binding property to the test purpose capturing substance; and

light absorbing particulates provided with a binding property to the reference purpose capturing substance.

{2} The kit according to item {1}, wherein a test purpose binding substance provided with a binding property to the target substance is introduced to the fluorescent particulates.
{3} The kit according to item {1}, wherein a reference purpose binding substance provided with a binding property to the reference purpose capturing substance is introduced to the light absorbing particulates.
{4} The kit according to item {1}, wherein the fluorescent particulates are at least one of silica particles, latex particles, and semi-conductor particles, and besides the light absorbing particulates are at least one of silica particles containing a labeling substance which has absorption wavelength in a wavelength range of visible light, latex particles containing a labeling substance, and colloidal metal particle.
{5} The kit according to item {1}, wherein one or both of the fluorescent particulates and the light absorbing particulates include silica particles, and the average particle diameter of the silica particles is from 20 to 1000 nm.
{6} A method of detecting based on immunochromatography, having the steps of:

preparing a planar test strip for immunochromatography, fluorescent particulates provided with a binding property to a target substance, and light absorbing particulates provided with a binding property to a reference purpose capturing substance, the reference purpose capturing substance being located in a reference area of the test strip;

applying the fluorescent particulates and the light absorbing particulates to the test strip;

applying a target substance to the test strip, thereby having the target substance bind to the fluorescent particulates, having the fluorescent particulates migrate over the planar test strip, and bring the fluorescent particulates to bind with the test purpose capturing substance in a test area through the target substance, besides bringing the light absorbing particulates to bind with a reference purpose capturing substance located in a reference area of the test strip; and

detecting the target substance based on fluorescence emission from the fluorescent particulates in the test area and light absorption of the light absorbing particulates in the reference area, without being inhibited by fluorescence from the reference area.

{7} The method of detecting based on immunochromatography according to item {6}, wherein the plurality of target substances are taken as a subject, the test area is divided into plural sections, and each of the plural target substances is separately detected in the plural test areas.
{8} The method of detecting based on immunochromatography according to item {6}, wherein
(A) application of the target substance to the test strip is performed by adding dropwise a sample liquid containing the target substance to a sample pad, or
(B) application of the fluorescent particulates, the light absorbing particulates, and the target substance to the test strip is performed by adding dropwise a sample liquid containing the fluorescent particulates, the light absorbing particulates, and the target substance to a sample pad.
{9} The method of detecting based on immunochromatography according to item {6}, wherein
(A′) application of the target substance to the test strip is performed by immersing a suction part of the test strip into a sample liquid containing the target substance, or
(B′) application of the fluorescent particulates, the light absorbing particulates, and the target substance to the test strip is performed by immersing a suction part of the test strip into a sample liquid containing the fluorescent particulates, the light absorbing particulates, and the target substance.
{10} The method of detecting based on immunochromatography according to item {6}, wherein the fluorescent particulates are at least one of silica particles, latex particles, and semi-conductor particles, and besides the light absorbing particulates are at least one of silica particles containing a labeling substance which has absorption wavelength in a wavelength range of visible light, latex particles containing a labeling substance, and colloidal metal particle.
{11} The method of detecting based on immunochromatography according to item {6}, wherein one or both of the fluorescent particulates and the light absorbing particulates include silica particles, and the average particle diameter of the silica particles is from 20 to 1000 nm.
{12} A labeling reagent for immunochromatography, having:

fluorescent particulates provided with a binding property to a target substance, the target substance provided with a binding property to a test purpose capturing substance, the test purpose capturing substance being located in a test area of a test strip; and

light absorbing particulates provided with a binding property to a reference purpose capturing substance, the reference purpose capturing substance being located in a reference area of the test strip.

{13} The labeling reagent according to item {12}, wherein a test purpose binding substance is incorporated into the fluorescent particulates, the binding substance provided with a binding property to a target substance.
{14} The labeling reagent according to item {12}, wherein a reference purpose binding substance is incorporated into the light absorbing particulates, the binding substance provided with a binding property to the reference purpose capturing substance.
{15} The reagent according to item {12}, wherein the fluorescent particulates are at least one of silica particles, latex particles, and semi-conductor particles, and besides the light absorbing particulates are at least one of silica particles containing a labeling substance which has absorption wavelength in a wavelength range of visible light, latex particles containing a labeling substance, and colloidal metal particle.
{16} The reagent according to item {12}, wherein one or both of the fluorescent particulates and the light absorbing particulates include silica particles, and the average particle diameter of the silica particles is from 20 to 1000 nm.

### {Labeling Reagent}

### (Fluorescent Particulates)

In the invention, the fluorescent particulates of a preferred embodiment are contained in a labeling reagent and have a surface modified with binding substance which recognizes a target substance (an analyte).

Average Particle Diameter

An average particle diameter of the labeling particles is, although not specifically limited, preferably from 20 to 1000 nm, more preferably from 20 to 600 nm, and still more preferably from 60 to 300 nm. If the particle diameter is excessively small, the detection sensitivity is lowered. On the other hand, when the particle diameter is excessively large, it may be the reason of clogging of a porous support (membrane) used for immunochromatography.

In the present invention, the average particle diameter is an average diameter of the circle (average circle-equivalent diameter) obtained by measuring an occupancy area of labeling particles from the total projected area of 50 labeling particles randomly selected from an image, which is obtained under transmission electron microscope (TEM), scanning electron microscope (SEM) and the like, using image processing equipment, dividing the total occupancy area with the number of the selected labeling particles (50 particles), and determining the circle having an area equivalent to that. The variation coefficient, so-called CV value, of the particle size distribution is not specifically limited, but preferably 15% or less, more preferably 10% or less, and particularly preferably 8% or less.

Materials Constituting Particulates

Materials of the fluorescent particulates that may be used include, although not specifically limited, silica particles and latex particles. As described above, the fluorescent particulates of the present embodiment may preferably have a surface which is modified with a substance that can recognize a target substance of an analyte. As for the surface modification method, a method generally used for those types of materials can be suitably used.

Silica Particles

In the present invention, the fluorescent particulates preferably include silica particles. The silica particles are not specifically limited, and silica particles obtained by any preparation method can be used. For example, silica particles containing a labeling substance, which are obtained by a method for producing colloidal silica particles that contain fluorescent pigment compounds disclosed in WO 2007/074722 A1, can be particularly preferably used. Specifically, the silica particles which contain a labeling substance can be obtained as below; the labeling substance is reacted with a silane compound to obtain a product via a covalent bond, ionic bond, or other chemical bond or adsorption, and then the reaction product is polymerized with one or more types of silane compound. As a preferred mode of producing the silica particles containing the labeling substance, production can be made by bringing a labeling substance into reaction with a silane coupling agent to obtain a product, and bringing the product obtained after forming covalent bond into polymerization with one or more types of silane compounds. The labeling substance includes one having an active group such as an N-hydroxysuccinimide (NHS) ester group, a maleimide group, an isocyanate group, an isothiocyanate group, an aldehyde group, a para-nitrophenyl group, a diethoxy methyl group, an epoxy group, and a cyano group. The silane coupling agent includes one having a substituent group (e.g., an amino group, a hydroxy group, and a thiol group) which reacts with those active groups.

Specific examples of the labeling substance having an active group (fluorescent substance) may include NHS ester group-containing labeling substances such as 5-(and -6)-carboxytetramethylrhodamine succinimidyl ester (trade name, manufactured by emp Biotech GmbH).

Examples of substituent group-containing silane-coupling agent include an amino group-containing silane-coupling agent such as γ-aminopropyl-triethoxysilane (APS), 3-[2-(2-aminoethylamino)ethylamino]propyltriethoxysilane, N-2-(aminoethyl)-3-aminopropylmethyldimethoxysilane, and 3-aminopropyl-trimethoxysilane. Among them, APS is preferable.

The silane compound to be polymerized is not particularly limited, and examples thereof include tetraethoxysilane (TEOS), γ-mercaptopropyl-trimethoxysilane (MPS), γ-mercaptopropyltriethoxysilane, γ-aminopropyl-triethoxysilane (APS), 3-thiocyanatopropyltriethoxysilane, 3-glycidyloxypropyl-triethoxysilane, 3-isocyanatopropyltriethoxysilane, and 3-[2-(2-aminoethylamino) ethylamino]propyl-triethoxysilane. Among them, TEOS, MPS, and APS are preferable. In the present embodiment, the labeling substance is immobilized in the silica particles.

According to the production as described above, spherical or almost spherical silica particles can be prepared. Meanwhile, the almost spherical particles mean particles having a major axis/minor axis ratio of 2 or less.

For obtaining silica particles having a desirable average particle diameter, it is possible to remove particles having an excessively large particle diameter or an excessively small particle diameter by ultrafiltration by using an ultrafiltration membrane such as YM-10 or YM-100 (trade names, all manufactured by Millipore Corporation) or by recovering a supernatant or precipitates only after performing centrifugal separation with suitable acceleration of gravity.

Latex Particles

In the invention, examples of the latex particles may include synthetic polymer particles consisting of polystyrene, styrene-sulfonic acid (salt) copolymer, styrene-methacrylic acid copolymer, acrylonitrile-butadiene-sulfonic acid copolymer, vinyl chloride-acrylic acid ester copolymer, or vinyl acetate-acrylic acid ester copolymer. Further, as for the method of coloring latex particles, methods disclosed in Japanese JP-A-2000-178309, JP-A-H10-48215, JP-A-H08-269207, JP-A-H06-306108 (JP-A means unexamined published Japanese patent application), or the like can be used. Immobilization of a fluorescent substance (labeling substance) for those kinds of particles can be suitably performed according to a common method. For example, reference can be made to Japanese JP-A-2005-534907, JP-A-2010-156642 and JP-A-2010-156640, or the like. As an example of commercially available fluorescent latex particles, xMAP (registered trademark) Multi-Analyte COOH Microspheres manufactured by Luminex is known (http://hitachisoft.jp/products/lifescience/lineup/luminex/about/bead.htmlhttp://hitac hisoft.jp/products/lifescience/pdf/the_luminex_labmap_system.pdf).

Surface Modification

A method of modifying surface of the labeling particles with a substance capable of recognizing an analyte is not specifically limited. For example, a substance capable of recognizing an analyte can be adsorbed onto the labeling particles, based on electrostatic attraction force, van der Waals force, hydrophobic interaction, or the like. Alternatively, they can be bound to each other via chemical bond using a cross-linking agent or a condensing agent. Further, when there is a thiol group present on the surface of the labeling particles, the thiol group of a substance capable of recognizing an analyte may be bound to an analyte via S—S bond.

Further, when particles are aggregated after binding with a substance capable of recognizing an analyte such as a biological molecule present on the surface of the labeling particles (e.g., antibody, antigen, DNA, and RNA), a surface treatment may be performed in advance for the surface of the labeling particles by using an alternate adsorption method. The alternate adsorption method indicates a method of forming a thin polymer film on the surface of a substrate or particles by adsorbing a polymer with charges onto the surface of a substrate or particles with charges based on electrostatic attraction force. Since charges can be given to the particle surface by performing an alternate adsorption treatment of surface of the labeling particles, electrostatic repulsive force is generated among the particles, yielding improved dispersion property. Further, since the polymer bound to the particles has displacement volume, the dispersion property is also improved due to an effect of steric repulsion force.

### (Light Absorbing Particulates)

The light absorbing particulates used in the invention are preferably at least one of silica particles containing a labeling substance which has absorption wavelength in a wavelength range of visible light, latex particles containing a labeling substance, and colloidal metal particle. In such case, it is preferable for the light absorbing particulates to have a surface modified with a biological molecule or the like which has a binding property to a reference purpose capturing substance. The type and shape thereof are not specifically limited. Preferred examples of the average particle diameter, constitutional materials, or the like of the light absorbing particulates are the same as those of the fluorescent particulates described above. The labeling substance is not particularly used if the constitutional material of the particulates has a light absorbing property. When a labeling substance (light absorbing substance) is applied, examples thereof that may be used include an organic pigment such as a polycyclic pigment and an azo pigment, and an inorganic pigment such as carbon black and ultramarine blue. For example, the light absorbing substance may be incorporated in the silica particles or latex particles. Further, the following semi-conductor particulates may be also preferably used as light absorbing particulates.

Semi-Conductor Particles or the Like

Materials of the semi-conductor particles are not specifically limited, but preferred examples thereof include ZnO, ZnS, ZnSe, ZnTe, CdO, CdS, CdSe, CdTe, HgS, HgSe, HgTe, InP, InAs, GaN, GaP, GaAs, TiO₂, WO₃, PbS, and PbSe. For example, semi-conductor nanoparticles disclosed in Japanese Patent No. JP-B-3897285 or the like may be used. The surface of the semi-conductor nanoparticles may be modified by substituting an atom such as S, O, Se, Te, P, As, and N present on surface of semi-conductor nanoparticles with a —SH group of a thiol compound. Examples of the gold particles and metal nanoparticles that may be used include colloidal gold particle and colloidal metal particle that are disclosed in the specification of JP-A-2003-26638 or the like. Specific examples of the colloidal metal particle include colloidal metal particle such as platinum, copper, and iron oxide. Examples of the inorganic crystals include iron oxide (III) (Fe₂O₃), silver oxide (I) (Ag₂O), tin oxide (IV) (SnO₂), titanium oxide (IV) (TiO₂), and indium tin oxide (ITO). The inorganic crystals disclosed in JP-A-2005-76064 may be used, for example.

Light Absorption Coefficient

The light absorbing particulates preferably absorb visible light and exhibit a color which is visually recognizable. Further, they are the particles preferably having molar absorption coefficient ε of 5×10⁶ M⁻¹cm⁻¹ or higher. Those having the molar absorption coefficient ε of 5×10⁷ M⁻¹cm⁻¹ to 1×10¹⁰ M⁻¹cm⁻¹ are more preferable.

As described herein, the molar absorption coefficient ε can be calculated based on the following Lambert-Beer equation.

A=Log₁₀(I₀/I)=εbp=aₛbp′

{A: absorbance, I: intensity of transmitted light, I0: intensity of incident light, ε: molar absorption coefficient (M⁻¹cm⁻¹), b: light passage length (cm), p: concentration of labeling particles (including mixture dispersion of coloration particles and fluorescent particulates) (M (mol/l)), aₛ: relative absorption coefficient, p′: concentration of labeling particles (including mixture dispersion of coloration particles and fluorescent particulates) (g/l)}.

The concentration p′ (g/l) is a value obtained by recovering only the labeling particles from a constant amount of dispersion containing labeling particles (e.g., 1 ml) and determining the dried mass. Meanwhile, the concentration p (mol/l) is a value obtained by determining the size of the labeling particles from a TEM image, calculating the volume of a single particle, determining mass of a single particle in view of density of the particle (e.g., 2.3 g/cm³ for silica particles), recovering only the labeling particles from a constant amount of dispersion containing labeling particles (e.g., 1 ml), and determining the mole number in view of the dried mass of the labeling particles. In the invention, the expression “molar absorption coefficient ε of the labeling particles” means molar absorption coefficient ε of labeling particles in the dispersion, which is obtained by measuring absorbance of dispersion containing the labeling particles and applying the result to the Lambert-Beer equation described above. The absorbance, absorption spectrum, and ε of the labeling particles can be measured from a dispersion such as aqueous dispersion, ethanol dispersion, or N,N-dimethyl formamide dispersion by using any light absorption spectrophotometer or a plate reader.

Embodiments of surface modification of the light absorbing particulates are the same as those of the fluorescent particulates described above. However, it is preferable that the light absorbing particulates be provided with a binding property to a reference purpose capturing substance and modified with a biological molecule or the like which has a binding property to a reference purpose capturing substance.

### (Test Stick)

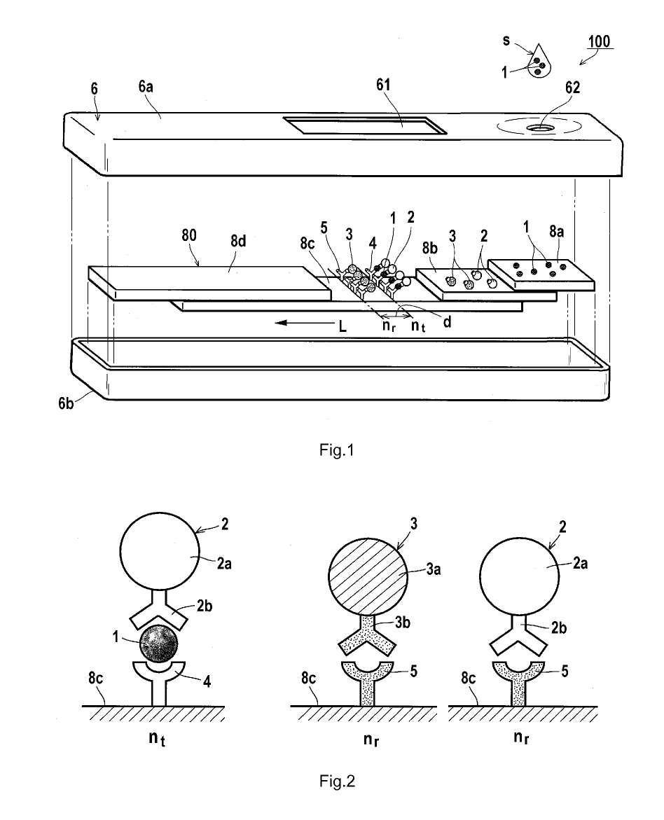

FIG. 1 is an exploded perspective view schematically illustrating the test stick as a preferred embodiment of the invention. A planar test piece (test strip) 80 of the present embodiment has, from the right side of FIG. 1, a sample pad 8a as a member to which a sample (an analyte) s containing an analyte substance (target substance) 1 is added. In addition, a conjugate pad 8b is provided next to it. Fluorescent labeling unit 2 and light absorbing labeling unit 3 are here given. The fluorescent labeling unit has fluorescent particulates to which a binding substance is incorporated, the binding substance capable of binding specifically to a target substance. The light absorbing labeling unit has light absorbing particulates to which a binding substance in incorporated, the binding substance capable of binding specifically to a capturing substance 5.

Further, there is a membrane 8c made of a porous support. A test area nₜ, is here given in which a test purpose capturing substance 4 is locally immobilized, the capturing substance being for capturing fluorescent particulates via the binding substance and target substance. In membrane 8c, a reference area nᵣ is also provided at the front position of the test area nₜ with regard to the forward direction L of the flow. A control line is formed so that a light absorbing labeling unit having the light absorbing particulate can be captured by an action of the reference purpose capturing substance 5 provided here. After that, to have the analyte liquid flow in the lateral flow direction (L), an absorption pad 8d is placed so as to absorb the analyte liquid from the membrane, and they are connected to each other in the order described above.

In other words, the planar test piece 80 has a structure in which each pair of the sample pad 8a and conjugate pad 8b, the conjugate pad 8b and membrane 8c, and the membrane 8c and absorption pad 8d is connected to each other while being partially overlapped. When an analyte liquid is applied onto the sample pad 8a, it moves in order from the conjugate pad 8b, the membrane 8c, and the absorption pad 8d based on capillary phenomenon (capillary tube force).

According to the present embodiment, the planar test piece 80 is sandwiched between an upper casing 6a and a lower casing 6b to give a test stick 100. On the upper casing 6a, a detection opening 61 and an analyte introducing opening 62 are provided. Through the detection opening 61, irradiation light is supplied to the test piece 80 present inside, and the fluorescence emitted therefrom can be collected, detected, and measured. Meanwhile, by supplying the analyte liquid “s” to the test piece 80 through the analyte introducing opening 62 for an measurement test can be carried out.

### DEFINITION OF TERMS

With regard to the definition of the terms used herein, the target substance 1 (the symbols shown in the drawings are also indicated, but it shall not be construed to be limited to them) is a substance as an object of detection by lateral flowmetry, and it has the same definition as the analyte substance included in an analyte. Binding substances 2b and 3b (FIG. 2) are substances having a binding property to the target substance and the capturing substance, respectively, and they are preferably biological molecules. Labeling particle 2a and 3a (FIG. 2) introduced with a labeling substance (not illustrated) are referred to as labeling unites 2 and 3. However, in broad sense, the term “labeling particle” may be used to have meaning which includes a labeling particle. Further, the labeling particles are a general name of fluorescent particulates and light absorbing particulates. The test purpose capturing substance 4 is a substance which is immobilized onto the membrane in a test area and captures the labeling unit 2 via the target substance 1. Meanwhile, the reference purpose capturing substance 5 is a substance which is immobilized onto the membrane in a reference area, and the labeling unit 3 is captured by it without being mediated by the target substance 1.

Further, as described herein, the substance not only means a chemical compound and a chemically synthesized molecule but also includes a biological molecule (e.g., protein, peptide, and nucleic acid), and it may have either an artificial origin or a natural origin. In broad sense, it includes cells of a living body, microorganisms (bacteria or the like), and viruses. In addition, the binding generally indicates a state in which plural pieces are assembled into a continuous and integral form, and, in addition to a chemical bond such as a covalent bond, an ionic bond, and a hydrogen bond, it includes chemical adsorption, physical adsorption, other physical link states such as assembling, a screw bond, and interlocking, or the like. As described herein, the binding may be a direct binding between plural pieces or an indirect binding via other piece.

Analyte

The analyte s used for the present embodiment is not specifically limited, and examples thereof include a clinical analyte represented by body fluid or feces of a human or an animal such as blood, plasma, serum, lymph fluid, urine, saliva, pancreatic fluid, stomach fluid, sputum, and swab collected from mucous membrane of a nose or a neck; a food analyte represented by liquid food, semi-solid food, and solid food; an analyte sampled from nature such as soil, river, and sea water; an analyte obtained by wiping of production line or a clean room in a plant; and an analyte sample from an environment represented by a sampling analyte by air sampler. When it is a liquid state, the analyte may be used as it is. When it is a semi-solid or solid state, it may be used after undergoing a treatment such as dilution and extraction.

Binding Substance

In the present embodiment, the test purpose binding substance 2b (FIG. 2) is used, being integrated with the labeling particle 2a (labeling unit 2). Specific examples of the binding substance 2b include, although not specifically limited, a biological molecule having a binding property to the target particles, specifically, an antibody. The binding substance may be directly bound and integrated with the target particles, or may be indirectly bound via other substance. Binding between target particles and the binding substance may be performed by a common method such as a physical adsorption based on hydrophobic interaction and a chemical binding method with an aid of a functional group like a binding between a succinimido group and an amino group and a binding between a maleimide group and a thiol group. When the target particles are nanoparticles, plural binding substances may bind to the surface of one labeling unit. Further, as for an embodiment of a labeling unit in which fluorescent silica particulates as labeling particles are integrated with a binding substance, reference can be made to WO 2008/018566 A.

According to the present embodiment, the reference purpose binding substance 3b is also used separately from the test purpose binding substance 2a. The reference purpose binding substance 3b has a binding property to a reference purpose capturing substance 5 which is described below. In addition, the labeling particles (light absorbing particulates) 3a and the reference purpose binding substance 3b are integrated to form a reference purpose labeling unit 3. Thus, during the course of migration along the membrane, the labeling unit 3 is captured by the capturing substance 5. A binding and integration mode between the labeling particle 3a and binding substance 3b or the preferred material type of the binding substance 3b is the same as those of the test purpose binding substance 2b. However, the reference purpose binding substance 3b preferably has no binding property to the test purpose capturing substance 4 and the target substance. Meanwhile, the test purpose binding substance 2b may have a binding property to the reference purpose capturing substance 5, but more preferably has no binding property thereto.

Test Purpose Capturing Substance

In the membrane used for the present embodiment, the test purpose capturing substance 4 is immobilized onto the material of membrane. The capturing substance 4 has a binding property to the target substance 1 in order to capture a complex including the labeling particle 2a, the binding substance 2b, and the target substance 1 (see, FIG. 2). Since the capturing substance 4 has this binding property, capturing of a complex consisting of the labeling unit 2 and the target substance 1 can be achieved. As a result, a fluorescence-emitting line caused by the labeling unit 2 is formed in the test area nₜ. Examples of a combination of the “biding substance”-“target substance”-“capturing substance” include the following, but the invention is not limited to them: antibody (B)-antigen (C) against antibody (B)-antibody (D) against antigen (C), antigen (E)-antibody (F) against antigen (E)-antibody (G) against antibody (F), nucleic acid (H)-nucleic acid (I) with a sequence complementary to nucleic acid (H)-nucleic acid (J) with a sequence complementary to nucleic acid (I) but different from sequence of nucleic acid (H), receptor (K)-ligand (L) for receptor (K)-antibody (M) against ligand (L), aptamer (N)-protein (O) specifically binding to aptamer (N)-aptamer (P) specifically binding to protein (O) at a site different from aptamer (N), aptamer (Q)-protein (R) specifically binding to aptamer (Q)-antibody (S) against protein (R).

Reference Purpose Capturing Substance

In the present embodiment, the reference purpose capturing substance 5 is immobilized in the reference area nᵣ of membrane, and it directly binds to the reference purpose binding substance 3b without being mediated by the target substance 1. Thus, when the labeling unit 3 mixed in a flowing analyte liquid s migrates without being bound to the target substance 1, it can directly capture the labeling unit 3 (see, FIG. 2). As a result, a line with absorption light emission from the labeling unit 3 is formed in the reference area nᵣ. The reference purpose capturing substance 5 is not specifically limited, and examples thereof include a biological molecule having a binding property to a binding substance. Specific examples thereof include an antibody.

The reference purpose capturing substance 5 in a reference area and the test purpose binding substance 2b may have a binding property. For such case, a test purpose fluorescent particulate 2a is captured in the reference area nᵣ. Specifically, both the light absorbing particulate 3a and fluorescent particulate 2a are captured in the reference area, and even in such case, colored state of the light absorbing particulates in the reference area can be visually recognized. Meanwhile, since the fluorescent labeling unit 2 having a target substance is already captured in the test area, there would be no problem for general use. The ratio of the fluorescent particulates that are captured in the reference area is, although not specifically limited, preferably as small as possible. More preferably, it is 30 to 0 number %, and still more preferably 15 to 0 number %.

Materials

Materials of each constitutional member which may be used for the planar test piece 80 of the present embodiment is not specifically limited, and any common member used for immunochromatographic test strip can be used. As for the sample pad and the conjugated pad, a pad made of glass fiber such as Glass Fiber Conjugate Pad (trade name, manufactured by MILLIPORE) is preferable. As for the membrane, a nitrocellulose membrane such as Hi-Flow Plus120 membrane (trade name, manufactured by MILLIPORE) is preferable. As for the adsorption pad, a cellulose membrane such as Cellulose Fiber Sample Pad (trade name, manufactured by MILLIPORE) is preferable. When an adhesive-attached backing sheet is used, examples thereof include AR9020 (trade name, manufactured by Adhesives Research).

Introduction of Labeling Particles to Conjugate Pad

With regard to fluorescent immunochromatographic test, it is preferable that fluorescent particulates, which are the same as coloration particles bound with a binding substance, be introduced in advance as a labeling unit to the conjugate pad. The content of labeling particles per unit area (cm²) of the conjugate pad is, although not specifically limited, preferably 20 μg/cm² to 2 mg/cm² and more preferably 20 to 200 μg/cm². When the content thereof is too high, the analyte binding number per single particle is lowered and the detection sensitivity is impaired. As for the introduction method, a method of coating dispersion of labeling particles, applying or spraying, and drying can be mentioned. At that time, it is also possible that coloration particles or fluorescent particulates are contained in advance, dried first, and then introduced with fluorescent particulates or coloration particles. Alternatively, the coloration particles and fluorescent particulates are mixed with each other in advance and then they can be introduced as mixed colloid.

{Detection Method}

Detection method using the labeling reagents for immunochromatography according to the preferred embodiment of the invention is explained herein below. The detection method using a test strip for immunochromatography may be performed by adding dropwise a sample liquid containing an analyte (sample) to a sample pad. Further, as an alternative method, it may be carried out by immersing a suction part of a test strip for suction type immunochromatography not having a sample pad in a sample liquid (sample) containing an analyte and fluorescent particulates and light absorbing particulates for detection. Color exhibition from the control line can be visually confirmed, and determination can be made as to whether it shows a positive or negative response.

Specific embodiments of the detection method based on immunochromatography are as follows:

(A) application of the target substance to the test piece can be performed by adding dropwise a sample liquid containing the target substance to a sample pad, or
(B) application of the fluorescent particulates, light absorbing particulates, and target substance to the test piece can be performed by adding dropwise a sample liquid containing the fluorescent particulates, light absorbing particulates, and target substance to a sample pad.
(A′) application of the target substance to the test piece can be performed by immersing a suction part of the test strip into a sample liquid containing the target substance, or
(B′) application of the fluorescent particulates, light absorbing particulates, and target substance to the test piece can be performed by immersing a suction part of the test strip into a sample liquid containing the fluorescent particulates, light absorbing particulates, and target substance.

Meanwhile, although the color exhibition from test line is not visually confirmed in the present embodiment, by observing the strip using a fluorescence detector for immunochromatography, determination of a positive response or negative response can be performed with high sensitivity. Meanwhile, according to the detection method using a test strip for immunochromatography of the present embodiment, the control line is colored by light absorbing particulates, and thus expiration of use can be confirmed by naked eye observation. In addition, as no fluorescence is emitted from the control line, fluorescence of test line can be determined with high sensitivity without being inhibited by fluorescence from control line. According to the detection method using a test strip for immunochromatography, it is preferable that naked eye determination is carried out first and then high-sensitive determination and/or quantitative measurement is performed by using a fluorescence detector.

Further, as described herein, the term “detect” includes meanings of qualitative detection and quantitative detection and also other various measurements, identifications, analyses, and evaluations.

From the viewpoint of significant exhibition of the effect of the invention, the following settings can be mentioned as preferred settings.

(1) Distance between test line and control line (d in FIG. 1) is preferably 1 mm or more, and more preferably 2 mm or more. The upper limit is not specifically limited, but practically 20 mm or less, or 10 mm or less, for example.
(2) Wavelength of fluorescence emission from fluorescent particulates on test line is generally 400 to 800 nm, and preferably 500 to 700 nm. Meanwhile, the absorption wavelength of the light absorbing particulates is preferably 400 to 800 nm, and more preferably 450 to 650 nm.

### {Detection Device}

Detection device for immunochromatography according to preferred embodiment of the invention includes a light source for excitation and a filter. Examples of the light source for excitation include a mercury lamp, a halogen lamp, a xenon lamp, a laser diode, and a light emitting diode. The filter can be a filter for transmitting only the light with specific wavelength from a light source for excitation, or, from the viewpoint of detecting fluorescence only, a filter for transmitting only fluorescence excluding excitation light, and it is suitably selected based on fluorescence wavelength of the fluorescent particulates, and fluorescence wavelength. The fluorescence detection device may be provided with a photoelectric multiplier tube for collecting the fluorescence or a CCD detector. Accordingly, fluorescence with visually undeterminable intensity or wavelength can be detected, and further quantification of an analyte can be made as its fluorescence intensity can be measured, enabling detection and quantification with high sensitivity.

Wavelength of the excitation light for irradiation is, although not specifically limited, preferably 300 to 900 nm, and more preferably between 400 and 800 nm. Wavelength of fluorescence emitted from the fluorescent particulates may vary depending on wavelength of excitation light for irradiation and type of fluorescent pigment. However, it is generally in the range of 400 to 800 nm.

Detection of the light absorbing particulates can be made based on a standard method, and it is also possible to carry out the detection based on naked eye observation without using a special device.

As another embodiment, there may be a case in which fluorescence collected by using a light collector is converted into a signal. In addition, it may be displayed as an image by using a liquid crystal display device connected before it. Accordingly, the signal may be sent to a memory device to store test record. Alternatively, it is also possible that a pre-determined image processing is performed to have more visible fluorescence emission state or an apparatus for automatic determination is used. Further, it is also possible to have a constitution that intensity of obtained detection signal is calculated so that quantification measurement of an analyte substance is automatically performed.

Examples of the light collector in a fluorescence detection device include a photo diode (PD), an avalanche diode (APD), a photoelectric multiplier tube (PMT), and CCD. From the viewpoint of production cost, it is preferably PD. More preferably, it is CAN-mounted PD which does not require any cumbersome production processes. Lens on a focusing surface of a CAN-mounted PD is not specifically limited, as long as the light from the focusing lens is collected by PD. For example, a CAN-mounted PD having rotationally symmetrical two convex lenses, which has diameter of 1.5 mm, a numerical aperture (NA) of 0.2 at focusing lens side, and a NA of 0.4 at PD side, is commercially available. In addition, with regard to the constitution of a device equipped with a detector or a quantification method using it, reference can be made to JP-A-2010-197248.

### MODIFIED EXAMPLE

As a modified example of the invention, it is also preferable that plural target substances are taken as a subject, the test area is divided into plural sections, and each of the plural target substances is separately detected in plural test areas. In other words, the immunochromatography test does not necessarily include two lines (one test line and one control line). According to immunochromatography for multi-item diagnosis, plural test lines exist. According to an influenza detection kit manufactured by DENKA SEIKEN Co., Ltd. (trade name: Quick Navi™-Flu), both type A influenza and type B influenza can be determined by a single flow test. When there is a positive response in such case, the control line exhibits a color (or light emission) in addition to any line of them. In particular, a kit for simultaneous detection of various items in addition to influenza will be available in future. For example, when plural lines for simultaneous detection of adenovirus, influenza, and RS virus are present on a single test strip and there are multiple infections, the control line may exhibit color or light emission in addition to plural test lines.

Even for such case, by suitably combining the fluorescent particulates and light absorbing particulates, problems associated with detection sensitivity when only the fluorescent particulates are used can be solved according to the invention, and thus the desired effect can be exhibited.

According to the test kit for immunochromatography of the invention or embodiments of the invention, a detection method using the test kit, and a labeling reagent used for the test kit, reduced visibility of fluorescence from a test line caused by fluorescence light emission from a control line can be suppressed or prevented. In addition, as the fluorescent particulates and light absorbing particulates are used in combination, expiration of use can be confirmed via visual observation.

The present invention will be described in more detail based on examples given below, but the invention is not meant to be limited by these.

### Examples

### Production Example 1

### Preparation of Labeling Particles

With regard to fluorescent pigment-containing silica was prepared, used as a core particle, by making rhodamine 6G be contained in silica particles having a particle diameter of about 300 nm, according to the method described in JP-A-2009-221059. Specifically, it was prepared according to the following method. 5-(and -6)-carboxy rhodamine 6G.succinimidyl ester (trade name: HiLyte, manufactured by Biosciences) was dissolved in dimethyl formamide (DMF), added with APS, and reacted for 1 hour at room temperature (23° C.) to obtain a DMF solution of carboxy rhodamine 6G-APS. To a mixture solvent of ammonia water and ethanol, the DMF solution of TEOS and carboxy rhodamine 6G-APS were added, and the mixture was stirred for 2 hours at 40° C. When the reaction is completed, particles were precipitated by performing centrifugation, and the supernatant was immediately removed. The obtained precipitates were re-dispersed in ethanol and again subjected to centrifugation to precipitate the particles and remove unreacted TEOS or the like. Further, the same washing procedures were repeated four times except that distilled water is used instead of ethanol. As a result, free pigment or the like was removed and the rhodamine 6G-containing silica particles with particle diameter of about 300 nm were prepared. The maximum absorption wavelength of rhodamine 6G as a fluorescent pigment in the particles was 535 nm.

### Production Example 2

### Antibody Modification of Fluorescent Particulates

To a colloid of the particles which have been prepared in the Production example 1, MES (2-Morpholinoethanesulfonic acid) buffer solution (pH 6.0), NHS, EDC (1-ethyl-3-(3-(dimethylamino)propyl)carbodiimide), and distilled water were added and mixed for 30 min.

The reaction solution was separated by centrifugation. After removing the supernatant, distilled water was added for dispersing the particles. The centrifugal separation and dispersion with distilled water were repeated in the same manner as above to wash the particles. At the final moment, the particles were dispersed in 1 mL of 50 mM KH₂PO₄ buffer solution (pH 8.0). To the resultant, anti-hCG antibody (Anti-hCG mouse IgG1, manufactured by Medix Biochemica) dissolved in a KH₂PO₄ buffer solution (pH 8.0) was added and mixed for 2 hours. Subsequently, BSA solution was added thereto and mixed again for 1 hour.

The reaction solution was separated by centrifugation. After removing the supernatant, a KH₂PO₄ buffer solution (pH 8.0) was added for dispersing the particles. Further, the centrifugal separation and dispersion with a KH₂PO₄ buffer solution (pH 8.0) were repeated in the same manner as above to wash the particles. Eventually, the particles were dispersed in 1 mL of KH₂PO₄ buffer solution (pH 8.0) to obtain colloid of anti-hCG antibody labeled with the fluorescent particulates.

### Production Example 3

### Modification of Anti-hCG Antibody with Coloration Particle

To Au colloid particles having a particle diameter of about 40 nm (manufactured by BBI), MES (2-Morpholinoethanesulfonic acid) buffer solution (pH 6.0), NHS, EDC (1-ethyl-3-(3-(dimethylamino)propyl)carbodiimide), and distilled water were added and mixed for 30 min.

The reaction solution was separated by centrifugation. After removing the supernatant, distilled water was added for dispersing the particles. Further, the centrifugal separation and dispersion with distilled water were repeated to wash the particles. At the final moment, the particles were dispersed in 1 mL of KH₂PO₄ buffer solution (pH 8.0). To the resultant, goat IgG antibody (goat IgG2b, manufactured by Takara Bio Inc.) dissolved in a KH₂PO₄ buffer solution (pH 8.0) was added and mixed for 2 hours. Subsequently, 100 μL of BSA solution was added thereto and mixed again for 1 hour.

The reaction solution was separated by centrifugation. After removing the supernatant, a KH₂PO₄ buffer solution (pH 8.0) was added for dispersing the particles. Further, the centrifugal separation and dispersion with a KH₂PO₄ buffer solution (pH 8.0) were repeated to wash the particles. At the final moment, the particles were dispersed in 1 mL of KH₂PO₄ buffer solution (pH 8.0) to obtain colloid of goat IgG antibody labeled with the fluorescent particulates.

### Example 1

### Production of Conjugate Pad Having Both Colored Latex Particles and Fluorescent Silica Particles

0.25 ml of the fluorescent silica particle colloid modified with an anti-hcG antibody (10 mg/ml) which has been prepared in the Production example 2, 0.05 ml of Au colloid particles modified with goat IgG antibody (10 mg/ml) which has been prepared in the Production example 3, 3 ml of 50 mg/ml sucrose, and 1.7 ml of distilled water were mixed with one another.

Subsequently, the mixed particle colloid was incorporated into Glass Fiber Conjugate Pad (trade name, manufactured by MILLIPORE, 8×150 mm) in an amount of 0.8 ml per each pad (Pad 101).

The Glass Fiber Conjugate Pad 101 incorporated with mixed particles of colored Au colloid particles and fluorescent latex particles exhibited pale red color, and incorporation of the particles in the pad can be confirmed via visual observation.

### Comparative Example 1

### Production of Conjugate Pad Having Fluorescent Silica Particles

0.3 ml of the fluorescent silica particle modified with an anti-hCG antibody (10 mg/ml) which has been prepared in the Production example 2, 3 ml of 50 mg/ml sucrose, and 1.7 ml of distilled water were mixed with one another. The obtained fluorescent silica particle colloid was incorporated into Glass Fiber Conjugate Pad (trade name, manufactured by MILLIPORE, 8×150 mm) in an amount of 0.8 ml per each pad. The Glass Fiber Conjugate Pad c01 incorporated with the particles exhibited pale red color, and incorporation of the particles in the pad can be confirmed via visual.

### Example 2

### Detection of Recombinant hCG Using Test Strip for Immunochromatography which is Prepared by Using Conjugate Pad 101 Incorporated with Mixed Particles of Colored Au Colloid Particles and Fluorescent Silica Particles

### (1) Preparation of Antibody Immobilized Membrane

Near the center of the membrane (length: 25 mm, trade name: Hi-Flow Plus120 membrane, manufactured by MILLIPORE) (about 12 mm from the end of the membrane), a solution ((50 mM KH₂PO₄, pH 7.0)+5% sucrose) containing anti-hCG antibody (alpha subunit of FSH (LH), clone code/6601, manufactured by Medix Biochemica) in an amount of 1 mg/mL was coated in a coating amount of 0.75 μL/cm to give a test line with width of about 1 mm.

Subsequently, as a control line with width of about 1 mm, a solution ((50 mM KH₂PO₄, pH 7.0), sugar free) containing goat IgG antibody (goat IgG2b, manufactured by Takara Bio Inc.) in an amount of 1 mg/mL was coated in a coating amount of 0.75 μL/cm followed by drying for 30 min at 50° C.

Next, as a blocking treatment, the entire membrane was immersed in a blocking buffer for 30 min at room temperature.

It was then transferred to a buffer for washing and stabilizing membrane and kept therein for 30 min at room temperature. Thereafter, the membrane was taken out, placed on a paper towel, and dried overnight at room temperature to give an antibody immobilized membrane.

The membrane obtained from above, the conjugate pad containing mixed particles of colored Au colloid particles and fluorescent silica particles obtained from the Example 1, a sample pad (Glass Fiber Conjugate Pad (GFCP), manufactured by MILLIPORE), and an absorbing pad (Cellulose Fiber Sample Pad (CFSP), manufactured by MILLIPORE) were assembled on top of a backing sheet (trade name: AR9020, manufactured by Adhesives Research). After that, it was cut to yield a strip with width of 5 mm and length of 60 mm to have the test strip 101 which has the constitution illustrated in FIG. 1. FIG. 1 is the same as those explanations given above. Meanwhile, the backing sheet was not illustrated.

Further, each constitutional member was attached such that both ends of each member are overlapped in an amount of 2 mm with neighboring member as illustrated in FIG. 1 (ditto for the followings). The distance d between test line and control line was 3 mm.

### (2) Detection of Recombinant hCG

100 μL of the recombinant hCG (manufactured by ROHTO PHARMACEUTICAL CO., LTD.) with concentration of 100, 50, 20, 10, 5, 2, 0.2, or 0.1 IU/L was added dropwise to the sample pad region of the strip. After keeping it for 5 min, color exhibition from the line coated with anti-hCG antibody (alpha subunit of FSH (LH), clone code/6601, manufactured by Medix Biochemica) (test line) and the line coated with the goat IgG antibody (control line) was confirmed by a naked eye. As a result, color exhibition from the control line was confirmed. Meanwhile, color exhibition from the test line was not confirmed by visual observation.

Subsequently, FF01-482 (trade name, manufactured by Semrock) and FF01-536 (trade name, manufactured by Semrock) were used as a filter at light source for excitation side and a filter at detector side, respectively, and the test strip added dropwise with a sample in which the recombinant hCG is 100, 50, 20, 10, 5, 0.2, or 0.1 IU/L was irradiated with a mercury lamp (103 W). Further, by using a CCD detector (trade name: C2741-35A, manufactured by Hamamatsu Photonics K.K.) as a detecting device, fluorescence was visualized as an image. As a result, from all samples in which the recombinant hCG is 100, 50, 20, 10, 5, 0.2, or 0.1 IU/L, fluorescent color exhibition was confirmed from both the test line and control line.

Based on the results described above, the test strip using mixed particles of colored Au colloid particles and fluorescent silica particles can be used for determination using a fluorescent detector even when the recombinant hCG is between 100 and 0.1 IU/L.

### Comparative Example 2

### Detection of Recombinant hCG Using Test Strip for Immunochromatography which is Prepared by Using Conjugate Pad Incorporated with Fluorescent Silica Particles

Detection of the recombinant hCG was made in the same manner as the Example 2(2) by using the test strip c01 which has been prepared in the same manner as the Example 2(1), except that the Conjugate Pad c01 incorporated with fluorescent silica particles is used as a conjugated pad. As a result of determining color exhibition from the lines of test strip after keeping for 5 min, no color exhibition was shown from any line.

According to the evaluation using a fluorescence detector, only from a sample in which the recombinant hCG is 100, 50, 20, 10, 5, 2, 0.2 IU/L was shown with fluorescence color exhibition from the test line and control line. When the recombinant hCG is 0.1 IU/L, no color exhibition was shown from the test line.

Based on the results given above, it was found that the test strip using the fluorescent silica particles can be determined with a fluorescence detector only when the recombinant hCG is 0.2 IU/L or more.

Having described the present invention as according to the present embodiments, it is our intention that the invention not be limited by any of the details of the description, unless otherwise specified, but rather be construed broadly within its spirit and scope as set out in the accompanying claims.

### EXPLANATIONS OF LETTERS OR NUMERALS

1 Target substance (analyte substance)
2 Fluorescent labeling unit
2a Fluorescent particulates
2b Test purpose binding substance
3 Light absorbing labeling unit
3a Light absorbing particulates
3b Reference purpose binding substance
4 Test purpose capturing substance
5 Reference purpose capturing substance
6 Casing
61 Opening for detection
62 Opening for introducing analyte
6a Upper casing
6b Lower casing
80 Planar test piece (test strip)
8a Sample pad
8b Conjugate pad
8c Membrane
8d Absorption pad
100 Test stick
nᵣ Reference area (control line)
nₜ Test area (test line)
L Lateral flow direction
S Analyte
d Distance between reference area (control line) and test area (test line)

1. A kit for immunochromatography, comprising:
a planar test strip comprising a test area and a reference area, the test area comprising a test purpose capturing substance, the reference area comprising a reference purpose capturing substance;
fluorescent particulates provided with a binding property to a target substance, the target substance provided with a binding property to the test purpose capturing substance; and
the light absorbing particulates provided with a binding property to the reference purpose capturing substance.

2. The kit according to claim 1, wherein a test purpose binding substance provided with a binding property to the target substance is introduced to the fluorescent particulates.

3. The kit according to claim 1, wherein a reference purpose binding substance provided with a binding property to the reference purpose capturing substance is introduced to the light absorbing particulates.

4. The kit according to claim 1, wherein the fluorescent particulates are at least one of silica particles, latex particles, and semi-conductor particles, and besides the light absorbing particulates are at least one of silica particles containing a labeling substance which has absorption wavelength in a wavelength range of visible light, latex particles containing a labeling substance, and colloidal metal particle.

5. The kit according to claim 1, wherein one or both of the fluorescent particulates and the light absorbing particulates include silica particles, and the average particle diameter of the silica particles is from 20 to 1000 nm.

6. A method of detecting based on immunochromatography, comprising the steps of:
preparing a planar test strip for immunochromatography, fluorescent particulates provided with a binding property to a target substance, and light absorbing particulates provided with a binding property to a reference purpose capturing substance, the reference purpose capturing substance being located in a reference area of the test strip;
applying the fluorescent particulates and the light absorbing particulates to the test strip;
applying a target substance to the test strip, thereby having the target substance bind to the fluorescent particulates, having the fluorescent particulates migrate over the planar test strip, and bring the fluorescent particulates to bind with the test purpose capturing substance in a test area through the target substance, besides bringing the light absorbing particulates to bind with a reference purpose capturing substance located in a reference area of the test strip; and
detecting the target substance based on fluorescence emission from the fluorescent particulates in the test area and light absorption of the light absorbing particulates in the reference area, without being inhibited by fluorescence from the reference area.

7. The method of detecting based on immunochromatography according to claim 6, wherein the plurality of target substances are taken as a subject, the test area is divided into plural sections, and each of the plural target substances is separately detected in the plural test areas.

8. The method of detecting based on immunochromatography according to claim 6, wherein
(A) application of the target substance to the test strip is performed by adding dropwise a sample liquid containing the target substance to a sample pad, or
(B) application of the fluorescent particulates, the light absorbing particulates, and the target substance to the test strip is performed by adding dropwise a sample liquid containing the fluorescent particulates, the light absorbing particulates, and the target substance to a sample pad.

9. The method of detecting based on immunochromatography according to claim 6, wherein
(A′) application of the target substance to the test strip is performed by immersing a suction part of the test strip into a sample liquid containing the target substance, or
(B′) application of the fluorescent particulates, the light absorbing particulates, and the target substance to the test strip is performed by immersing a suction part of the test strip into a sample liquid containing the fluorescent particulates, the light absorbing particulates, and the target substance.

10. The method of detecting based on immunochromatography according to claim 6, wherein the fluorescent particulates are at least one of silica particles, latex particles, and semi-conductor particles, and besides the light absorbing particulates are at least one of silica particles containing a labeling substance which has absorption wavelength in a wavelength range of visible light, latex particles containing a labeling substance, and colloidal metal particle.

11. The method of detecting based on immunochromatography according to claim 6, wherein one or both of the fluorescent particulates and the light absorbing particulates include silica particles, and the average particle diameter of the silica particles is from 20 to 1000 nm.

12. A labeling reagent for immunochromatography, comprising:
fluorescent particulates provided with a binding property to a target substance, the target substance provided with a binding property to a test purpose capturing substance, the test purpose capturing substance being located in a test area of a test strip; and
the light absorbing particulates provided with a binding property to a reference purpose capturing substance, the reference purpose capturing substance being located in a reference area of the test strip.

13. The labeling reagent according to claim 12, wherein a test purpose binding substance is incorporated into the fluorescent particulates, the binding substance provided with a binding property to a target substance.

14. The labeling reagent according to claim 12, wherein a reference purpose binding substance is incorporated into the light absorbing particulates, the binding substance provided with a binding property to the reference purpose capturing substance.

15. The reagent according to claim 12, wherein the fluorescent particulates are at least one of silica particles, latex particles, and semi-conductor particles, and besides the light absorbing particulates are at least one of silica particles containing a labeling substance which has absorption wavelength in a wavelength range of visible light, latex particles containing a labeling substance, and colloidal metal particle.

16. The reagent according to claim 12, wherein one or both of the fluorescent particulates and the light absorbing particulates include silica particles, and the average particle diameter of the silica particles is from 20 to 1000 nm.
